(19) United States
(12) Patent Application Publication
(10) Pub. No.: US 2011/0214918 A1
(43) Pub. Date: Sep. 8, 2011

(54) Excavation Apparatuses and Methods

(76) Inventors: Joshua N. Keck, Greenacres, WA (US); James H. Tippett, Spokane, WA (US)

(21) Appl. No.: 12/674,267

(22) PCT Filed: Aug. 21, 2008
(86) PCT No.: PCT/US08/73880

§ 371 Date: Feb. 19, 2010

Related U.S. Application Data
(60) Provisional application No. 60/965,662, filed on Aug. 21, 2007.

(51) Int. Cl. E21B 7/00; E21B 19/08; B25D 16/00

(52) U.S. Cl. 175/57; 175/203; 175/293

(57) ABSTRACT

Excavation apparatus are provided that can include a fixed portion configured to couple with a first conduit, a rotatable extendible portion movably coupled to the fixed portion, and a coiled conduit associated with extendible portion and in fluid communication with the first conduit. Excavation methods are provided that can include extending an excavating tool from an excavation apparatus to within an excavation site while rotating the excavating tool in relation to a fixed portion of the excavation apparatus, and maintaining fluid communication between the fixed portion and the excavating tool.

### CLAIM FOR PRIORITY

This application claims priority to U.S. Provisional Patent Application Ser. No. 60/965,662 which was filed on Aug. 21, 2007, the entirety of which is incorporated by reference herein.

### TECHNICAL FIELD

The present disclosure relates to excavation apparatuses and methods.

### BACKGROUND

Excavation equipment is used throughout the world. The mining and construction industries have become reliant on excavation equipment for the removal of earthen material from excavation sites. The sites can be holes and/or tunnels that can be used for a variety of purposes: in construction they are used to provide footings; and in mining they are used for exploration as well as recovery of valuable deposits. The material to be excavated from the sites can vary from loose soil at one extreme, to very hard solid rock at the other.

### SUMMARY

Excavation apparatus are provided that can include a fixed portion configured to couple with a first conduit, a rotatable extendible portion movably coupled to the fixed portion, and a coiled conduit associated with extendible portion and in fluid communication with the first conduit.

Excavation methods are provided that can include extending an excavating tool from an excavation apparatus to within an excavation site while rotating the excavating tool in relation to a fixed portion of the excavation apparatus, and maintaining fluid communication between the fixed portion and the excavating tool.

### BRIEF DESCRIPTION OF THE DRAWINGS

Embodiments of the disclosure are described below with reference to the following accompanying drawings.

FIG. 1 is an excavation apparatus according to an embodiment.

FIG. 2 is an excavation tool according to an embodiment.

FIG. 3 is an excavation apparatus according to an embodiment.

FIG. 4 is the excavation apparatus of FIG. 3 in one configuration.

FIG. 5 is the excavation apparatus of FIG. 3 in another configuration.

FIG. 6 is an excavation apparatus component coupling assembly according to an embodiment.

FIG. 7 is another view of the assembly of FIG. 6 according to an embodiment.

FIG. 8 is another view of the assembly of FIG. 6 according to an embodiment.

FIG. 9 is another view of the assembly of FIG. 6 according to an embodiment.

FIG. 10 is an excavation apparatus according to an embodiment.

FIG. 11 is the excavation apparatus of FIG. 10 in one configuration.

FIG. 12 is the excavation apparatus of FIG. 10 in another configuration.

FIG. 13 is the excavation apparatus of FIG. 10 in still another configuration.

### DESCRIPTION

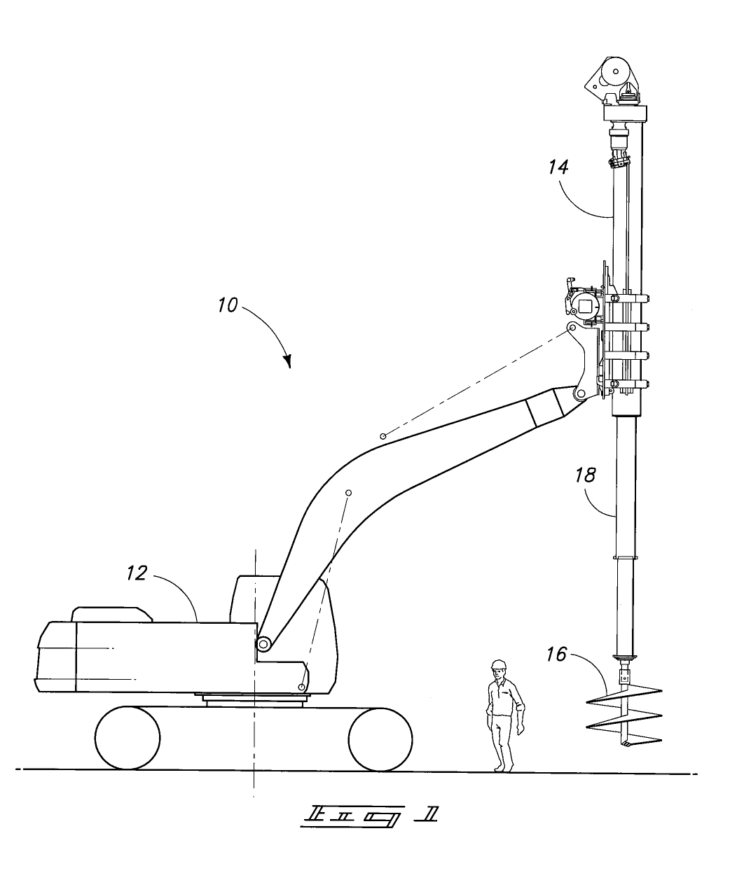

Excavation and apparatuses and methods are described with reference to FIGS. 1-13. Referring to FIG. 1, excavation equipment 10 can incorporate: a drill carrier 12 which can be configured to support and provide power to an earth drill 14. Carrier 12 can be a crawler track or wheel-mounted machine that includes articulation functions configured to provide for the positioning of the drill. Drill 14 can be configured to support and/or provide excavation power to an excavation tool 16 such as an auger. Drill 14 can include a rotary motion generator for rotating the tool 16 about its vertical axis. Drill 14 can also be configured to lower, crowd, and/or raise the tool 16.

Drill 14 can also include a telescoping apparatus 18 such as Kelly Bars configured to provide a mechanical link between drill 14 and the tool 16. Apparatus 18 can be configured to allow transmission of rotary torque and vertical down-force to tool 16. Apparatus 18 can be supported by a winch driven wire rope that is threaded through the top end of apparatus 18 and connected to a very inner member of apparatus 18 via a swivel joint (not shown). Apparatus 18 can be projected from drill 14 by paying out wire rope from the winch while relying on gravitational force for extension. Each member of apparatus 18 can be fitted with stops that can engage as each member reaches its full extension, and stopping each member from completely exiting apparatus 18. The fit between the members of apparatus 18 can be relatively loose to allow the members to extend and retract freely in the very dirty and sometimes wet environment of a drilled shaft, for example.

Tool 16 can be configured to provide for the cutting and excavation of earth such as soil and/or rock from an excavation site such as a hole. Tool 16 can include augers, core barrels, buckets and DTH hammers. Tool 16 can include cutting edges or bits, and may also be configured to retain cut spoils, for example.

Equipment 10 can be configured to extend tool 16 from drill 14 to the bottom of a hole using apparatus 18, for example. Once at the bottom of the hole, the rotary motion generator of drill 14 can be engaged and the rotation and torque can be transmitted along the longitudinal axis of the members and to tool 16. Downward force on tool 16 can result from tool 16 and apparatus 18 weight, for example. As another example, equipment 10 may be configured to transmit downward force via crowding through apparatus 18, such as auto-locking bars, pinned bars, and/or friction locks.

As tool 16 rotates, it can advance into the earth and the site (e.g., hole and/or tunnel) can fill with spoil. Once full of spoil, the rotation can be stopped and tool 16 can be retracted from the hole. The spoil can be removed from the site, and then the drilling cycle repeated until the required depth is reached.

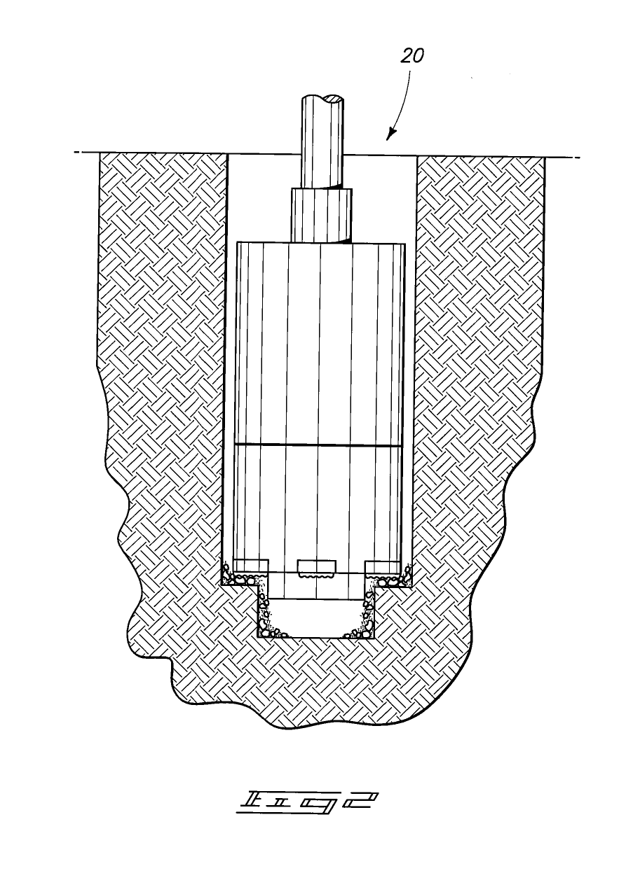

Referring to FIG. 2, when excavating rock, one of the most efficient excavation tools available is a hammer 20, such as a pneumatic driven Down-The-Hole (DTH) Hammer. Typically, a hammer 20 can advance through rock at a rate of 4 feet per hour. Conventional tooling such as augers and core barrels equipped with tungsten-carbide drag bits may require 8 hours to achieve 4 feet.

When hammer 20 is used, it can be fed compressed air through hollow drill stems. The limitation of using fixed length drill stems, versus telescoping apparatus such as Kelly Bars, is that as the hole depth reaches the extent of an individual stem, another stem must then be threaded onto the drill string. Stems are added as required to reach the bottom of the hole. When the cutting basket of hammer 20 is full of spoil, the hammer-stem assembly is hauled back up the hole and any stems that were added to the drill string on the way down, must now be removed on the way up. This is a very time consuming and labor intensive process.

The current limitation to hammer 20 use with telescoping apparatus such as Kelly Bars is that there exists no way of delivering pressurized air down to the rotating hammer through the telescoping apparatus. To date, “sealing” a set of telescoping apparatus such as Kelly Bars has not been accomplished to allow air to be fed down the center of the members. Kelly Bars, for example, are loosely fit and work in a very dirty/muddy environment, and it is not reasonable to try to make, and maintain them to be pressure-tight.

Some work has been done to try to feed an air hose down the hole, parallel to the Kelly Bars. One of the issues encountered with this method is that unless a rotary air swivel is fitted to the top of hammer 20, the air hose becomes wrapped around the Kelly Bars as the bar/hammer are rotated. Additionally, feeding the hose into the hole and hauling it back out is difficult when it is considered that the air hose is very bulky (typically 3 to 4 inch diameter hose is used).

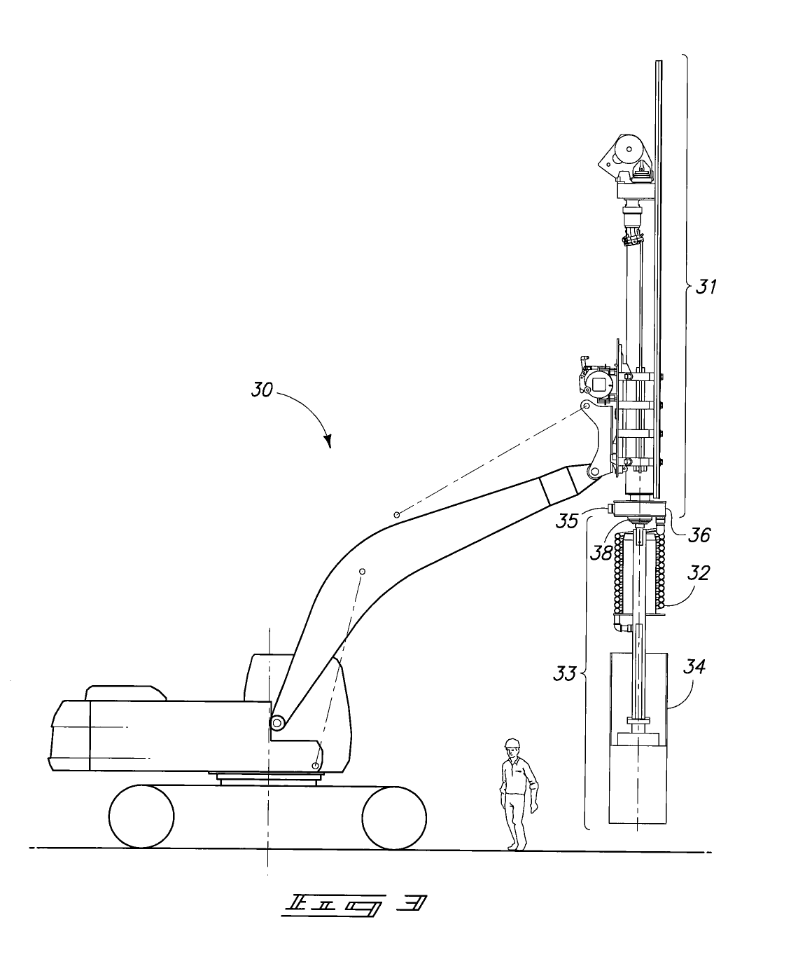

Referring to FIG. 3, an excavation apparatus 30 is depicted that can include a fixed portion 31 coupled to a rotatable extendible portion 33. Fixed portion 31 can be configured to couple with an excavator, for example. The fixed portion can have an inner recess 41 configured to receive at least some of portion 33 in some positions. Portion 33 can include telescoping apparatus 38 that can be configured to telescopically extend from portion 31, for example. According to one configuration, portion 33 can include a set of telescoping extendible Kelly bars. Portion 33 can have a first end extending to second end along portion 33 longitudinal axis with apparatus 38 being configured to rotate about this axis. A first end apparatus 38 can be rotatably coupled to portion 31, and this first end can extend to a second end that is configured to be coupled to an excavation tool 34. As an example, the excavation tool can be a DTH hammer.

Fixed portion 31 can include a first conduit 35 and this conduit can be in fluid communication with a coiled conduit 32 associated with extendible portion 33. Conduit 32 can be in fluid communication with tool 34 as well, for example, and conduits 35 and/or 32 can be configured to provide fluid, in liquid and/or gaseous form, between portion 31 and tool 34. As an example, these conduits can be configured to provide pressurized air between portion 31 and tool 34.

In order to provide for the transportation of pressurized air to tool 34, a coiled, flexible hose may be utilized. Referring to FIG. 3, equipment 30 can include a conduit 32 formed into a continuous coil. Conduit 32 can be coiled about the longitudinal axis of the portion 33, for example. According to other implementations, conduit 32 can be coiled about the exterior of portion 33. This coil of hose can then be expanded like a coiled extension spring to accommodate the lowering of tool 34 during excavation.

An excavation component coupling assembly 36 such as a rotary air swivel can be configured to couple portions 31 and 33. Assembly 36 can be included above conduit 32, and can be configured to allow the coil to rotate with telescoping apparatus 38 and tool 34. Assembly 36 can include a non-rotating portion that can be configured to deliver pressurized air from a ground based compressor(s) (not shown) and hose. Assembly 36 can remain above ground so issues associated with attempting to feed and retrieve a hose into and out of a site can be avoided.

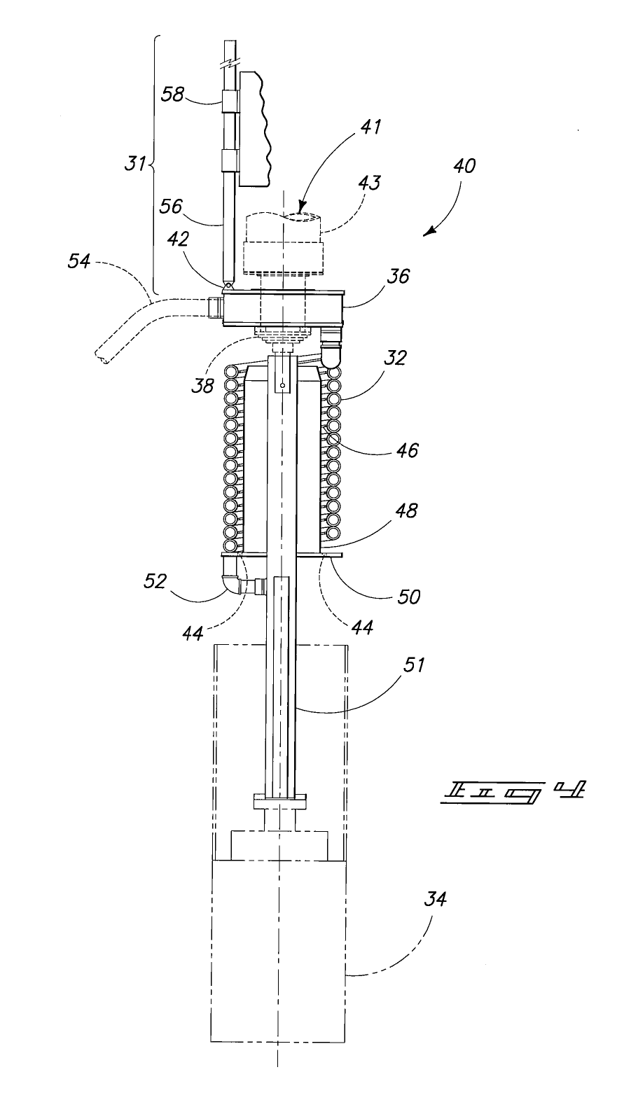

Referring to FIG. 4, equipment 40 can include telescoping apparatus 38 housing 43 with apparatus 38 fixedly coupled to a portion of assembly 36. Assembly 36 can be configured to provide for the disconnect of rotary motion between a ground based air compressor via air delivery conduit 54 and conduit 32, such as a 3″ diameter hose.

A fixed portion of assembly 36 can be coupled to portion 31. According to example implementations, assembly 36 can include a member 42 extending therefrom. Member 42 can be configured to be affixed to a rod 56 extending from portion 31. Rod 56 can be an anti-rotation bar within guides 58, for example. Rod 56 and guides 58 can be configured to provide for the rotational restraint of the non-rotating portion of the assembly 36, for example. Rod 56 and guides 58 can be configured as a square section steel tube that runs within fixed square guides. The square within a square fit of the bar to the guides can provide for torque reaction while still allowing for relative vertical motion.

Assembly 36 can also be coupled to conduit 32 which can be configured as a conduit for pressurized air to be transported to tool 34, for example. Conduit 32 can be a non-collapsing type that is flexible enough to be coiled to radius that will fit within the diameter of an excavated hole. A number of available chemical and fuel transfer hoses meet the requirements for this application and can be used as conduit 32. The shape and action of conduit 32 can be controlled by coiled spring 46 to which it is coupled.

Coiled spring 46 can provide for support and control of the conduit 32. Coiled spring 46 can be a continuous coil of alloyed spring steel material that has been formed to a diameter that, when mated with conduit 32, will allow the coil stack to fit within the diameter of an excavated hole, for example. Included with coiled spring 46 can be formed saddles that provide for clamping conduit 32 to spring 46. The top end of spring 46 can be fixed to the rotating portion of assembly 36. The bottom end of the spring can be fixed to a conduit support table 50.

Conduit support table 50 can be configured as the base plate onto which conduit 32 is stacked. Both the spring 46 and conduit 32 can terminate at the table 50. Table 50 can be fixed to a drill stem 51 which is in turn fixed to tool 34. Table 50 may be configured with cutouts 44 to facilitate exhaust air from tool 34 to escape up the excavated hole, for example.

Conduit 32 may be configured around hose centering mandrel 48 which can be configured to provide lateral support of conduit 32 and spring 46. Mandrel 48 can be of large enough diameter to provide adequate support of the coiled stack, but small enough to allow the coiled conduit to freely drop onto the mandrel. Mandrel 48 can be constructed of 1 to 2 inch diameter pipe/tubing to form a cage. The cage type construction may allow debris to fall through and not build up within the coil stack

Mandrel 48 may encompass drill stem 51 that can provide support of the configuration of assembly 36, conduit 32, spring 46, mandrel 48, and table 50, for example. At its lower end, stem 51 may rigidly fasten to the top of tool 34. At its top end, the stem 51 may include a telescoping apparatus box such as a kelly box into which a telescoping apparatus such as a Kelly Bar stub can plug into and pin off. The bottom portion of stem 51 can be hollow, and with the addition of air transfer plumbing 52, may permit the passage of pressurized air into tool 34.

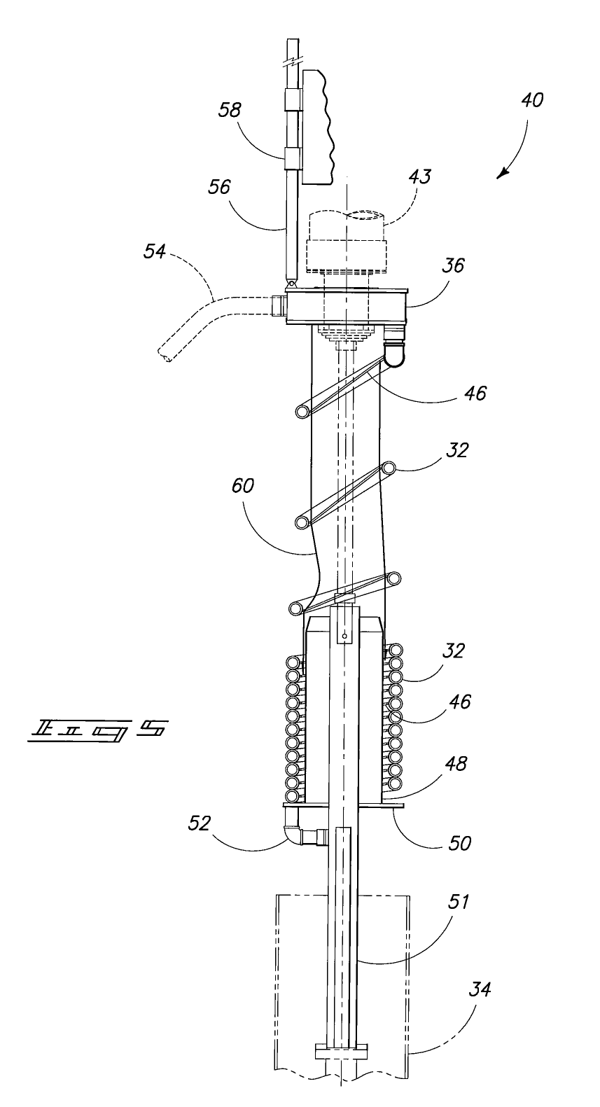

Referring to FIG. 5, equipment 40 can also include coil extension limiter lanyards 60 that can be configured to limit the maximum extent to which each coil can stretch. This can prevent the coiled spring 46/conduit 32 from becoming damaged due to over extension. Individual lanyards 60 can be constructed from small diameter wire rope with a crimped-on stop lug on each end, for example. Each hose saddle on the coiled spring can include holes through which lanyards 60 are threaded and retained with the crimped-on stop lugs. Two lanyards 60, positioned 180 degrees apart, may be utilized that will span between each set of adjacent coils.

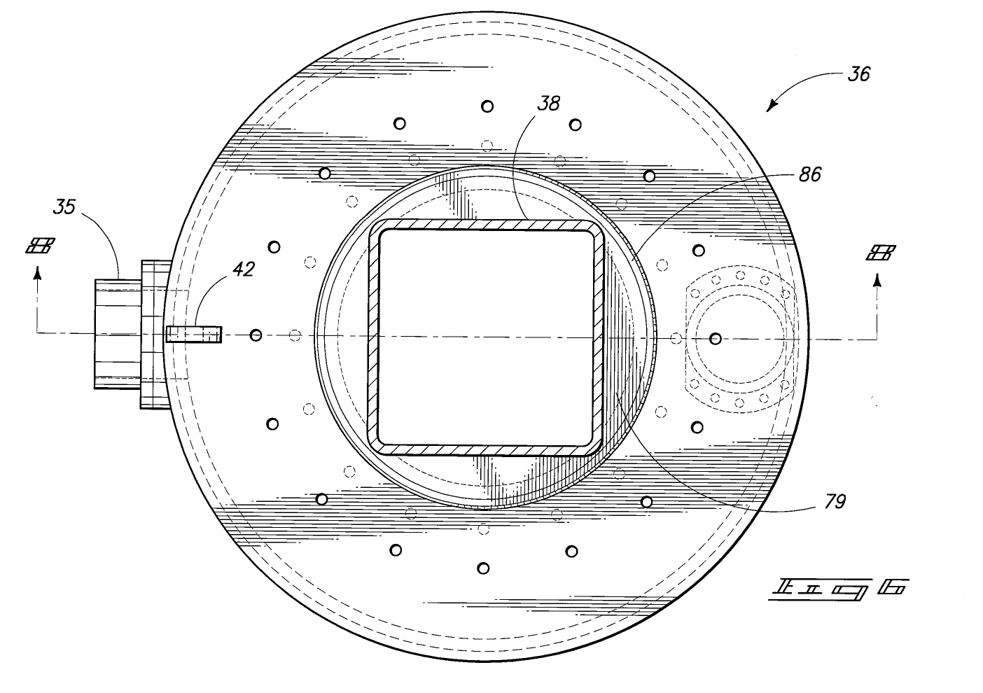

Referring to FIGS. 6-9, more detailed views of assembly 36 are depicted according to example embodiments. Assembly 36 can be configured to provide fluid communication between a fixed portion and rotating portion. Assembly 36 can include first plate 80 and second plate 82 having exterior wall 84 and interior wall 86 therebetween. Exterior wall 84 can extend from plate 80 and slidably couple 77 with second plate 82. Interior wall 86 can extend from second plate 82 and slidably couple 88 with first plate 80. The plates, interior and exterior wall can define a void 90 within assembly 36. First plate 80 can be above second plate 82 in one cross section. First plate 80 and exterior wall 84 individually further define recesses 77 and 88 respectively that are configured to retain O-rings, for example.

A first opening 92 within exterior wall 84 can be in fluid communication with void 90. A second opening 94 within second plate 82 can be in fluid communication with void 90. Void 90 can be configured to retain the fluid described herein.

First plate 80 can be configured to be coupled to a fixed portion of an excavation apparatus. First plate 80 can include a member 42 extending therefrom, the member configured to be affixed to a rod extending from the fixed portion of the excavation apparatus.

Flange 79 can be affixed to second plate 82 and can be configured to be coupled to apparatus 38 of portion 33. Flange 79 can be configured to fixedly engage a rotatable portion apparatus 33. According to example implementations, second plate 82 can be configured to rotate about exterior wall 84.

According to example embodiments, assembly 36 can generally include two portions, a rotating and non-rotating portion. The outside diameter and top can be the non-rotating portion, and the inside diameter and bottom can be the rotating portion. The connection between the two halves is accomplished through the use of a pair of large diameter ball bearings. The connection between the two halves also includes a pair of rotary seals to contain the pressurized air (150 to 200 psi).

The bore through the center of assembly 36 can be large enough to allow it to be slipped onto and encompass a portion of apparatus 38 such as Kelly bars. Once around apparatus 38, the inner space of assembly 36 can be engaged to the outer, telescoping member. This engagement can fix the inner space to the member in both the rotational and vertical axes. Assembly 36 can follow the outer member through its range of travel. Also included with assembly 36 can be air inlet and outlet fittings, and a mounting provision for an anti-rotation device.

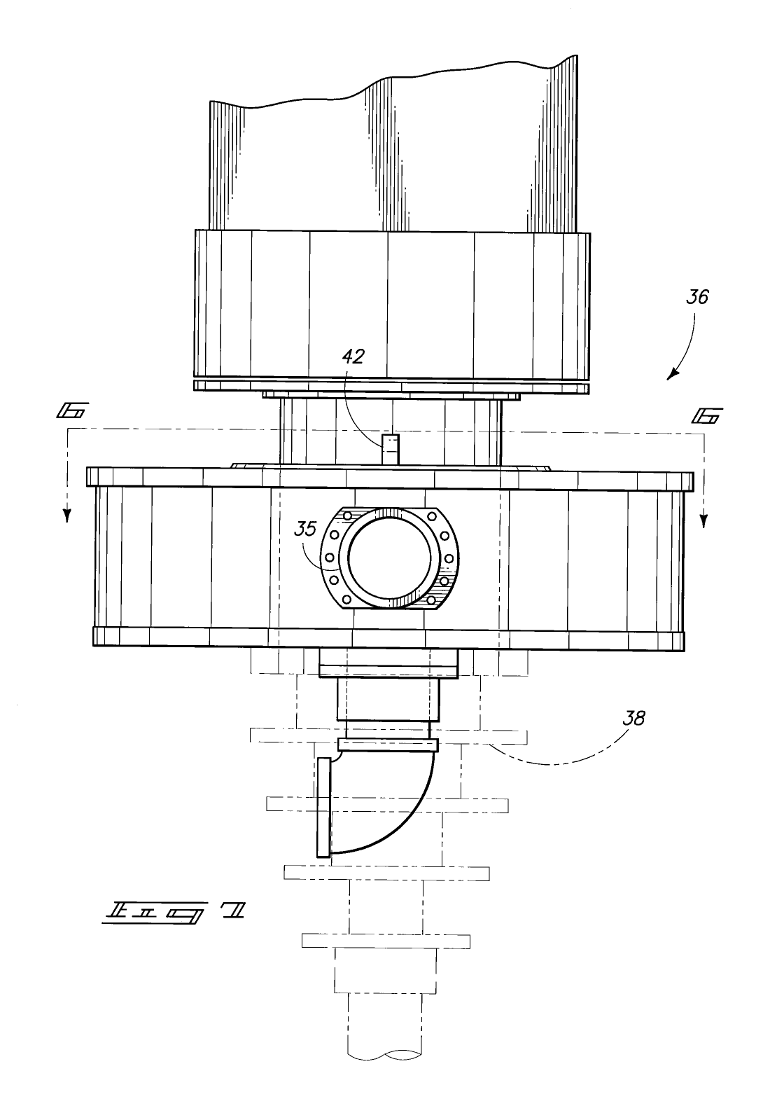

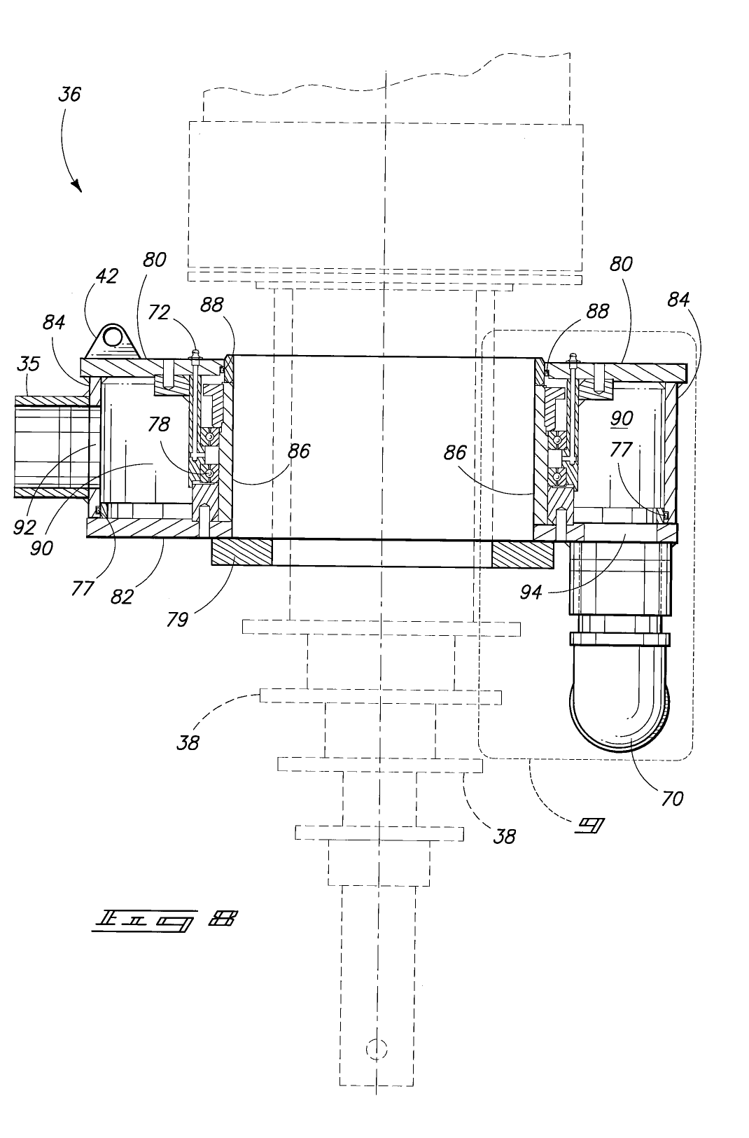

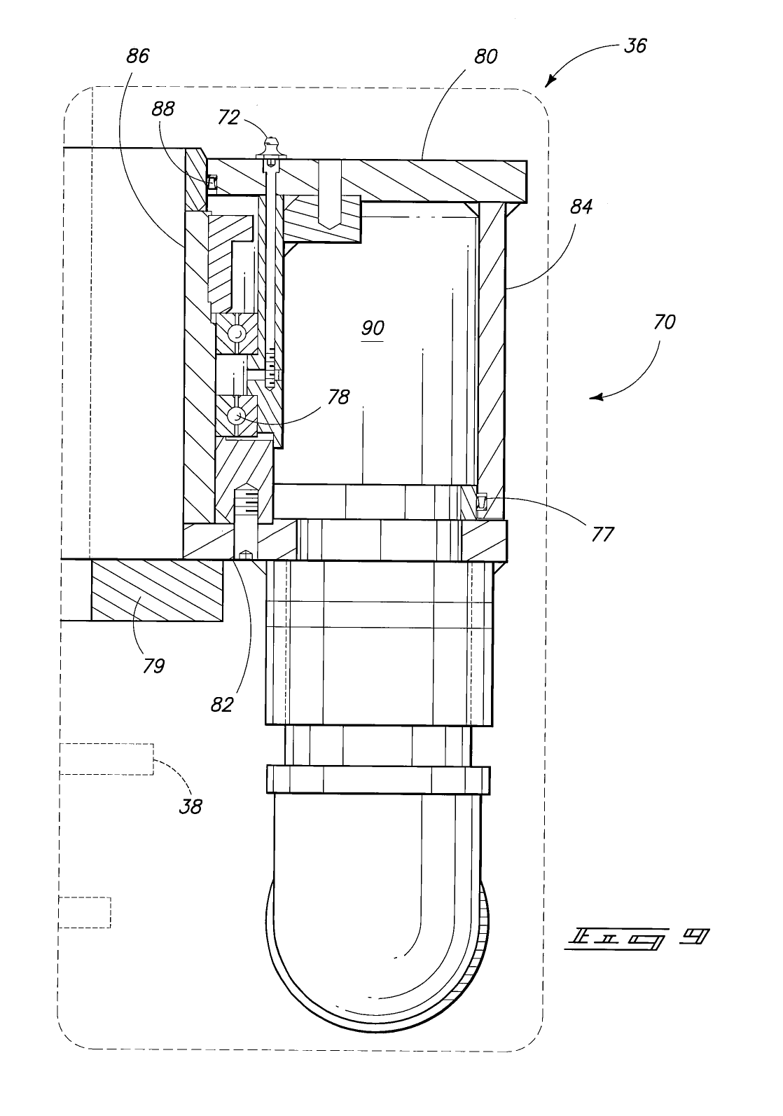

Referring to FIG. 6, an upper view of assembly 36 is depicted according to an embodiment. Assembly 36 can encompass telescoping apparatus 38, for example, which may be 12 inches square. Referring to FIG. 7, assembly 36 is shown encompassing apparatus 38 from another view. In this view assembly 36 has a height which can be about 10 inches and a diameter which can be about 33 inches. Referring to FIG. 8, a cross section of assembly 36 is shown that includes an air outlet elbow 70 that can be approximately 4 inches. Assembly 36 can include lube places 72 and an anti-rotation member 42 as well as air inlet coupling 35. Assembly 36 can also include rotary seals 77 and 88, ball bearings 78, such as Kaydon KG180SPO bearings, and rotation engagers 79, for example. The seal inner diameter can be about 17½ inches while the seal outer diameter can be about 30¾ inches. A distance from the center line of telescoping apparatus 38 to centerline of air outlet elbow 70 can be about 13 inches. Referring to FIG. 9, an expanded view of air outlet elbow 70 is given.

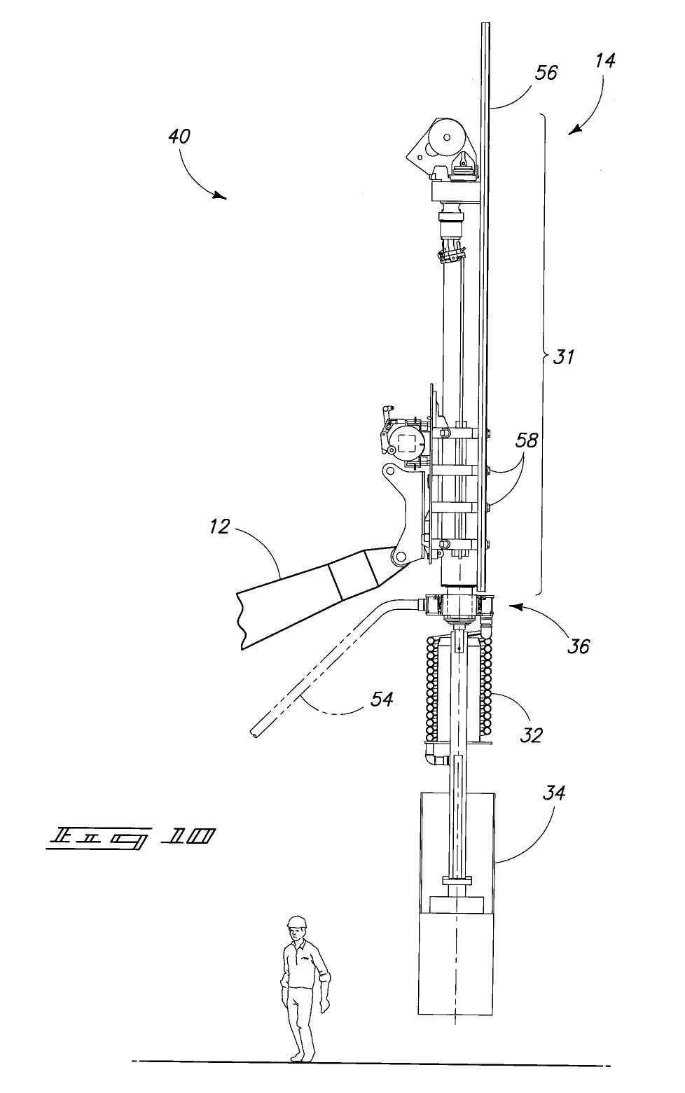

Referring to FIGS. 10-13, sequences of operation of equipment 40 are shown at numerous stages. An excavation method utilizing equipment 40, for example, can include extending excavating tool 34 from an excavation apparatus 14 to within an excavation site 110 while rotating excavating tool 34 in relation to fixed portion 31 of apparatus 14, and maintaining fluid communication between fixed portion 31 and excavating tool 34.

The method can include expanding coiled conduit 32 between fixed portion 31 and excavating tool 34 to maintain fluid communication between fixed portion 31 and excavating tool 34. According to example implementations, coiled conduit 32 can rotates complementary with excavating tool 34. Coiled conduit 32 can expand within excavation site 110.

The method can also include providing compressed air to excavating tool 34 while both extending excavating tool 34 from the excavation apparatus and rotating excavating tool 34. Tool 34 can also be retracted from excavating site 110. This retracting can include compressing coiled conduit 32 between fixed portion 31 and excavating tool 34 and maintaining fluid communication between fixed portion 31 and excavating tool 34.

According to example implementations, a set of operable telescoping members can be provided within an interior of fixed portion 31 of excavation apparatus 14. The method can include operably projecting the telescoping members from the interior as well as further include expanding coiled conduit 32 complementary with the operable projection of the telescoping members. The method can include rotating the telescoping members along their longitudinal axis.

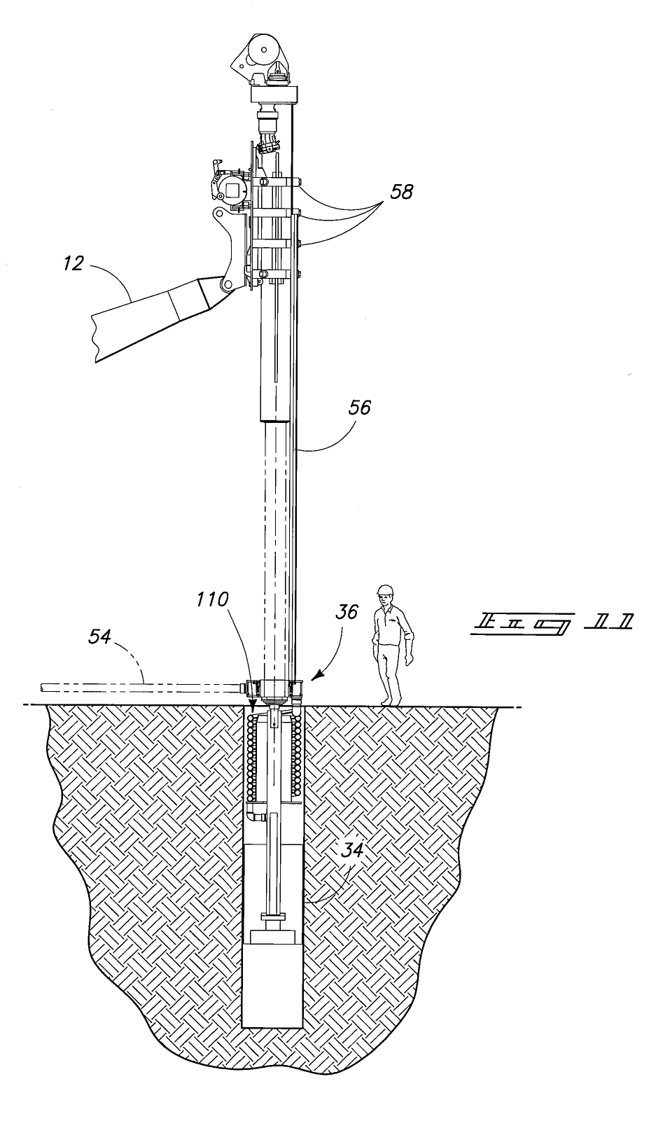

Referring to FIG. 10, the drilling apparatus is shown fully retracted and ready to begin excavating a hole. Referring to FIG. 11, the hole has progressed to where the drill is fully crowded down and the outer telescoping apparatus member is extended to its stops.

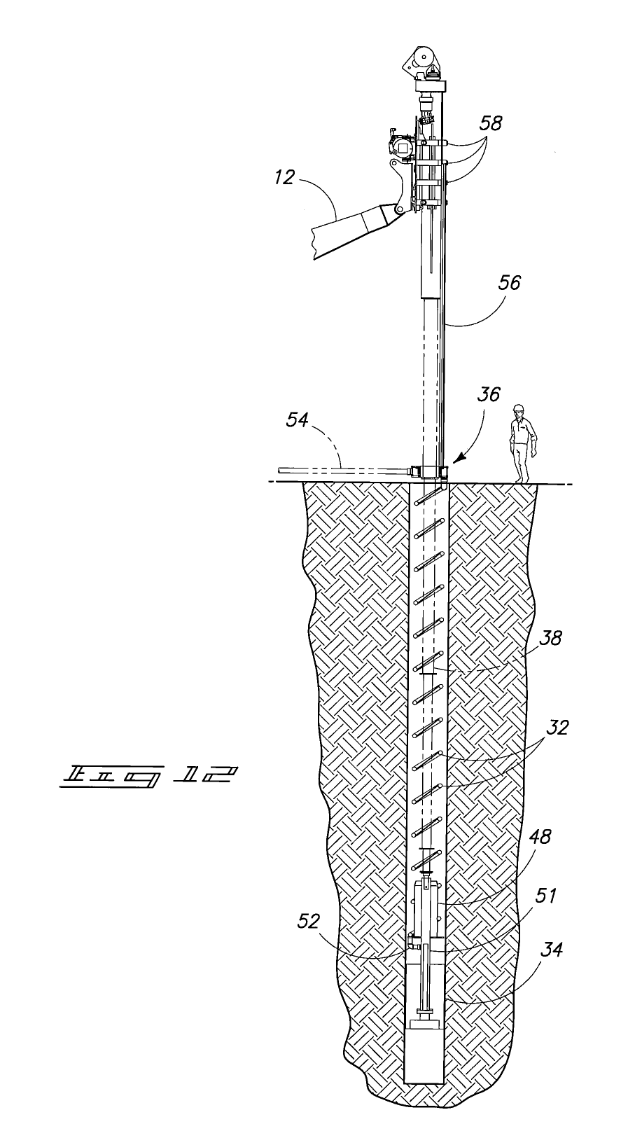

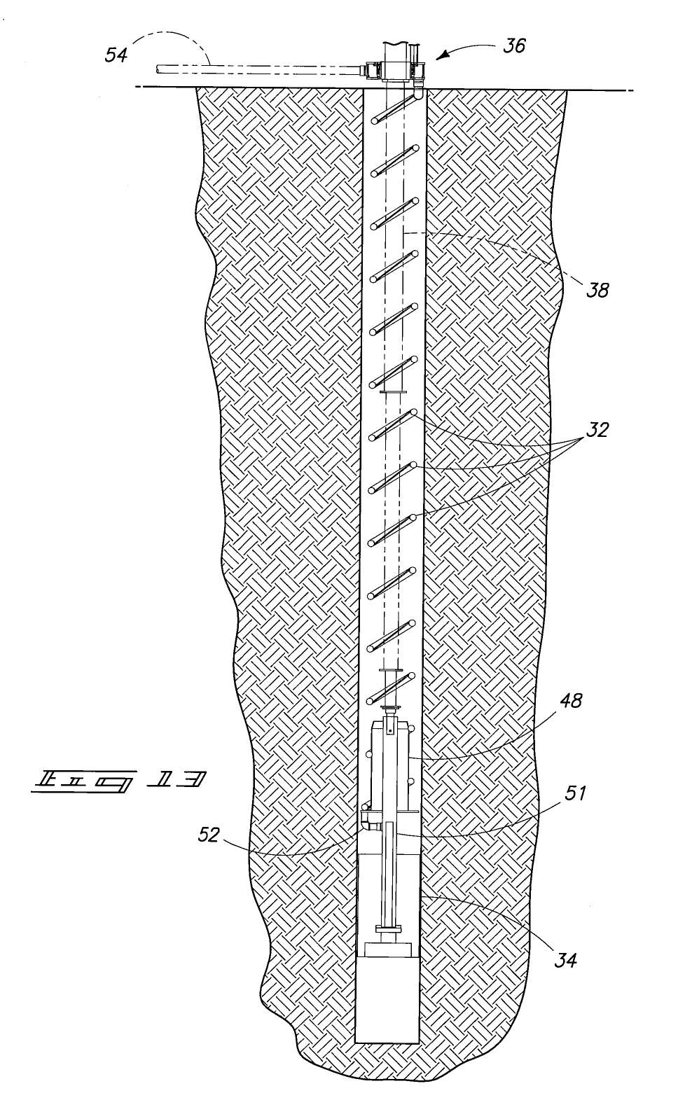

Assembly 36 can be aligned at its lowest point and can travel no further down. Referring to FIGS. 12-13, the hole has now reached the maximum achievable depth for the example hose coil shown (100 feet of hose). For deeper depths, a taller Coiled Hose stack would be required.

1. An excavation apparatus comprising:
a fixed portion configured to couple with a first conduit;
rotatable extendible portion movably coupled to the fixed portion; and
a coiled conduit associated with the extendible portion and in fluid communication with the first conduit.

2. The apparatus of claim 1 wherein the fixed portion is configured to be coupled to an excavator.

3. The apparatus of claim 1 wherein the first conduit is configured to convey pressurized air.

4. The apparatus of claim 1 wherein the rotatable extendible portion is configured to telescopically extend.

5. The apparatus of claim 1 wherein the rotatable extendible portion comprises a telescoping set of Kelly bars.

6. The apparatus of claim 1 wherein the rotatable extendible portion comprises a first end rotatably coupled to the fixed portion and a second end configured to be coupled to a cutting tool.

7. The apparatus of claim 6 wherein the cutting tool is a DTH hammer.

8. The apparatus of claim 1 wherein the rotatable extendible portion comprises a first end extending along its longitudinal axis to a second end, the extendible portion configured to rotate about its longitudinal axis.

9. The apparatus of claim 8 wherein the coiled conduit is coiled about the longitudinal axis of the extendible portion.

10. The apparatus of claim 8 wherein the coiled conduit is coiled about the exterior surface of the extendible portion.

11. An excavation component coupling assembly configured to provide fluid communication between a fixed portion and rotating portion, the assembly comprising:
first and second plates having exterior and interior walls therebetween, wherein the exterior wall extends from the first plate and slidably couples with the second plate, and the interior wall extends from the second plate and slidably couples with the first plate, the plates, interior and exterior walls defining a void within the assembly;
a first opening within the exterior wall and in fluid communication with the void; and
a second opening within the second plate and in fluid communication with the void.

12. The assembly of claim 11 wherein the first plate is configured to be coupled to a fixed portion of an excavation apparatus.

13. The assembly of claim 12 wherein the first plate further comprises a member extending therefrom, the member configured to be affixed to a rod extending from the fixed portion of the excavation apparatus.

14. The assembly of claim 11 further comprising a flange affixed to the second plate and configured to be coupled to a rotatable portion of an excavation apparatus.

15. The assembly of claim 14 wherein the flange is configured to fixedly engage the rotatable portion of the excavation apparatus.

16. The assembly of claim 11 wherein the first plate is above the second plate in one cross section.

17. The assembly of claim 11 wherein the second plate is configured to rotate about the exterior wall.

18. The assembly of claim 11 wherein the void is configured to retain a fluid.

19. The assembly of claim 18 wherein the fluid is compressed air.

20. The assembly of claim 11 wherein the first plate and the exterior wall individually further define recesses configured to retain O-rings

21. An excavation method comprising extending an excavating tool from an excavation apparatus to within an excavation site while rotating the excavating tool in relation to a fixed portion of the excavation apparatus, and maintaining fluid communication between the fixed portion and the excavating tool.

22. The method of claim 21 further comprising expanding a coiled conduit between the fixed portion and the excavating tool to maintain fluid communication between the fixed portion and the excavating tool.

23. The method of claim 22 wherein the coiled conduit rotates complementary with the excavating tool.

24. The method of claim 22 wherein the coiled conduit expands within the excavation site.

25. The method of claim 21 further comprising providing compressed air to the excavating tool while both extending the excavating tool from the excavation apparatus and rotating the excavating tool.

26. The method of claim 21 further comprising retracting excavating tool from the site.

27. The method of claim 26 further comprising compressing a coiled conduit between the fixed portion and the excavating tool to maintain fluid communication between the fixed portion and the excavating tool.

28. The method of claim 21 further comprising providing a set of operable telescoping members within an interior of a fixed portion of the excavation apparatus, and the extending comprises operably projecting the telescoping members from the interior.

29. The method of claim 28 further comprising expanding a coifed conduit complementary with the operable projection of the telescoping members.

30. The method of claim 28 further comprising rotating the telescoping members along their longitudinal axis.
